(19) United States
(12) Patent Application Publication
(10) Pub. No.: US 2023/0113293 A1
(43) Pub. Date: Apr. 13, 2023

(54) JACKFRUIT FLOUR, METHOD OF PREPARATION AND USES THEREOF

(71) Applicant: James Joseph, Kerala (IN)

(72) Inventor: James Joseph, Kerala (IN)

(73) Assignee: GOD'S OWN FOOD SOLUTIONS PVT LTD, KERALA (IN)

(21) Appl. No.: 18/046,705

(22) Filed: Oct. 14, 2022

(30) Foreign Application Priority Data
Oct. 16, 2015 (IN) 5560/CHE/2015

(51) Int. Cl. A21D 2/36; A23L 11/00; A23L 13/40; A23L 19/00; A23L 33/20; A23L 33/22; A23L 7/10

(52) U.S. Cl. CPC A21D 2/36; A23L 7/198; A23L 11/05; A23L 13/426; A23L 19/01; A23L 33/20; A23L 33/22

(57) ABSTRACT

The present disclosure relates to jackfruit flour prepared from various parts of the jackfruit, which can be used as an additive or a substitute for human consumption, offering reducing in glycemic load, reduced calorie intake, and increased fiber content. Method of preparation of said jackfruit flour, and uses and also described in the instant disclosure.

### FIELD OF INVENTION

The present disclosure relates to jackfruit flour, method of preparation, and utility of the jackfruit flour as a flour substitute or additive or as a meat substitute or additive for reducing glycemic load, increasing fiber content, or reducing calorie intake.

### BACKGROUND OF THE INVENTION

Currently Jackfruits are used during the season as a fruit or as a vegetable ingredient in several traditional Indian dishes. During off season, it is used as fried or dried chips, or as canned fruit. Around 75-80% of the Jackfruits in India are not consumed or wasted as there is no technical know how as to how to process the same and utilize it as a food or ingredient in several food products even though there is severe food scarcity in the country.Rs.2000 Crores worth of jack fruits are wasted even during severe drought conditions in India and when other crops fail. An organised market for Jackfruit can act as a shock absorber against farmer suicide during drought.

Diabetic patients are encouraged to switch to gluten free wheat, or reduce wheat, rice, or traditional flour intake by substituting the same with healthier options such as millet. However, use of millet leads to change in texture and taste of the food making it less palatable. It also leads to loss of binding capacity of the flour, thus making it dry.

### SUMMARY OF THE INVENTION

In an aspect of the present disclosure, there is provided jackfruit flour prepared from jackfruit parts selected from the group consisting of fruits or parts thereof, seeds or parts thereof, strands, and combinations thereof.

In an aspect of the present disclosure, there is provided a process of preparing jackfruit flour comprising the steps of: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof from said jackfruit; (c) drying fruits or parts thereof, seeds or parts thereof, strands, and combinations thereof to achieve moisture content less than about 8%; and (d) grinding fruits or parts thereof, seeds or parts thereof, strands, and combinations thereof to particle size in the range of 200-1000 µm to obtain jackfruit flour.

In an aspect of the present disclosure, there is provided a process of preparing jackfruit flour comprising the steps of: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands from said jackfruit; (c) drying fruits or parts thereof, seeds or parts thereof, and strands to achieve moisture content less than about 8%; and (d) grinding fruits or parts thereof, seeds or parts thereof, and strands to particle size in the range of about 200-1000 µm to obtain jackfruit flour.

In an aspect of the present disclosure, there is provided a fortified flour composition comprising: (a) at least one flour; and (b) jackfruit flour prepared from jackfruit parts selected from the group consisting of fruits or parts thereof, seeds or parts thereof, strands, and combinations thereof, wherein flour to jackfruit flour w/w ratio is in the range of 9:1-1:99.

In an aspect of the present disclosure, there is provided jackfruit flour prepared from jackfruit parts selected from the group consisting of fruits or parts thereof, seeds or parts thereof, strands, and combinations thereof for use as a meat additive or meat substitute.

In an aspect of the present disclosure, there is provided jackfruit flour prepared from jackfruit parts selected from the group consisting of fruits or parts thereof, seeds or parts thereof, strands, and combinations thereof for use as a flour additive or flour substitute.

In an aspect of the present disclosure, there is provided a method of reducing the glycemic load, reducing calorie amount, and increasing fiber content of food, said method comprising the steps of: (a) obtaining jackfruit flour prepared from jackfruit parts selected from the group consisting of fruits or parts thereof, seeds or parts thereof, strands, and combinations thereof; or fortified flour composition comprising (i) at least one flour; and (ii) said jackfruit flour, wherein flour to jackfruit flour w/w ratio is in the range of 9:1-1:99; and (b) contacting said jackfruit flour or fortified flour composition with food, wherein jackfruit flour or fortified flour composition weight percentage is in the range of 10-99%.

In an aspect of the present disclosure, there is provided a composition comprising jackfruit extract prepared from jackfruit fruits or parts thereof, seeds or parts thereof, strands, and combinations thereof, wherein said composition moisture content is in the range of about 65-80%.

In an aspect of the present disclosure, there is provided a method of preparing a composition, said method comprising: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, and strands from said jackfruit; and (c) grinding isolated fruits or parts thereof, seeds or parts thereof, and strands to obtain a composition, wherein said composition moisture content in the range of about 65-80%.

In an aspect of the present disclosure, there is provided a composition comprising jackfruit extract prepared from jackfruit fruits or parts thereof, seeds or parts thereof, strands, and combinations thereof, wherein said composition moisture content is in the range of about 40-60%.

In an aspect of the present disclosure, there is provided a method of preparing a composition, said method comprising: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, and strands from said jackfruit; and (c) grinding isolated fruits or parts thereof, seeds or parts thereof, and drying to obtain a composition, wherein said composition moisture content in the range of about 40-60%.

In an aspect of the present disclosure, there is provided a composition comprising jackfruit extract prepared from jackfruit fruits or parts thereof, seeds or parts thereof, strands, and combinations thereof, wherein said composition moisture content is less than about 8%.

In an aspect of the present disclosure, there is provided a method of preparing a composition, said method comprising: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, and strands from said jackfruit; and (c) grinding isolated fruits or parts thereof, seeds or parts thereof, and strands, and drying to obtain a composition, wherein said composition moisture content is less than about 8%.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE ACCOMPANYING DRAWINGS

The following drawings form part of the present specification and are included to further illustrate aspects of the present disclosure. The disclosure may be better understood by reference to the drawings in combination with the detailed description of the specific embodiments presented herein.

FIG. 1 depicts the glycemic load of a single serving of jackfruit flour, wheat flour, and white rice, in accordance with an embodiment of the present disclosure.

FIG. 2 depicts the calorie value of a single serving of jackfruit flour, wheat flour, and white rice, in accordance with an embodiment of the present disclosure.

FIG. 3 depicts the time line of change in plasma levels of glucose by jackfruit flour or glucose, in accordance with an embodiment of the present disclosure.

### DETAILED DESCRITION OF THE PRESENT INVENTION

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively, and any and all combinations of any or more of such steps or features.

### Definitions

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

“Jackfruit” ( Artocarpus heterophyllus) is a tree native to parts of South Asia, and Southeast Asia, and is a member of the Moraceae family.

“Fortified flour” refers to flour (such as wheat for instance) to which various nutrients or other flours are added to improve its nutritive value.

“Saturated fats” refers to type of fats in which the fatty acids have single bonds.

“Fats” refers to esters of three fatty acid chains and glycerol.

“Dietary fiber” refers to the indigestible portion of food derived primarily from plants sources. It mainly comprises “soluble fiber” and “insoluble fiber”. Soluble fiber dissolves in water, is fermented in the colon. It also provides binding characteristics. Insoluble fiber does not dissolve in water, is metabolically inert and adds bulk to food.

“Meat” refers to animal flesh which is eaten as food. It also refers to protein from animal sources.

“Glycemic load” refers to measure of both the quality (the GI value) and quantity (grams per serve) of a carbohydrate in a meal. A food’s glycemic load is determined by multiplying its glycemic index by the amount of carbohydrate the food contains in each serve and dividing by 100.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

The present disclosure is not to be limited in scope by the specific embodiments described herein, which are intended for the purposes of exemplification only. Functionally-equivalent products, compositions, and methods are clearly within the scope of the disclosure, as described herein.

In an embodiment of the present disclosure, there is provided jackfruit flour prepared from jackfruit parts selected from the group consisting of fruits or parts thereof, seeds or parts thereof, strands, and combinations thereof.

In an embodiment of the present disclosure, there is provided jackfruit flour as described herein, wherein said jackfruit parts are fruits or parts thereof, seeds or parts thereof, and strands.

In an embodiment of the present disclosure, there is provided jackfruit flour prepared from fruits or parts thereof, seeds or parts thereof, and strands as described herein, wherein said flour may comprise rind or core in quantities insufficient to significantly alter binding characteristics.

In an embodiment of the present disclosure, there is provided jackfruit flour prepared from fruits or parts thereof, seeds or parts thereof, and strands as described herein, wherein said flour may comprise rind or core in quantities insufficient to significantly alter taste profile.

In an embodiment of the present disclosure, there is provided jackfruit flour prepared from fruits or parts thereof, seeds or parts thereof, and strands as described herein, wherein said flour may comprise rind or core in quantities insufficient to significantly alter nutrition profile.

In an embodiment of the present disclosure, there is provided jackfruit flour as described herein, wherein flour particle size is in the range of about 200-1000 µm.

In an embodiment of the present disclosure, there is provided jackfruit flour as described herein, wherein flour particle size is in the range of about 300-900 µm.

In an embodiment of the present disclosure, there is provided jackfruit flour as described herein, wherein flour particle size is in the range of about 400-800 µm.

In an embodiment of the present disclosure, there is provided jackfruit flour as described herein, wherein flour particle size of about 500 µm.

In an embodiment of the present disclosure, there is provided jackfruit flour as described herein, wherein flour moisture content is less than about 8%.

In an embodiment of the present disclosure, there is provided jackfruit flour as described herein, wherein flour moisture content is less than about 7%.

In an embodiment of the present disclosure, there is provided jackfruit flour as described herein, wherein flour moisture content is less than about 6%.

In an embodiment of the present disclosure, there is provided jackfruit flour as described herein, wherein flour moisture content is less than about 5%.

In an embodiment of the present disclosure, there is provided jackfruit flour as described herein, wherein said flour is characterized in that said jackfruit flour comprises: (a) total fats having weight percentage in the range of about 0.3-1.5% in said flour, wherein total fats do not comprise detectable levels of saturated fats; (b) proteins having weight percentage in the range of about 7-9% in said flour; and (c) total carbohydrates having weight percentage in the range of about 78-82% in said flour, wherein said carbohydrates comprise dietary fiber having weight percentage in the range of about 12-16% of said flour, and sugars having weight percentage in the range of about 3-11% of said flour, wherein dietary fiber comprises soluble fiber having weight percentage in the range of about 3-6% of said flour, and insoluble dietary fiber having weight percentage in the range of about 8-12% in said flour.

In an embodiment of the present disclosure, there is provided jackfruit flour as described herein, wherein said flour is characterized in that said jackfruit flour comprises: (a) total fats having weight percentage in the range of about 0.5-1.2% in said flour, wherein total fats do not comprise detectable levels of saturated fats; (b) proteins having weight percentage in the range of about 7.6-8.7% in said flour; and (c) total carbohydrates having weight percentage in the range of about 79-81% in said flour, wherein said carbohydrates comprise dietary fiber having weight percentage in the range of about 13-15% of said flour, and sugars having weight percentage in the range of about 3-11% of said flour, wherein dietary fiber comprises soluble fiber having weight percentage in the range of about 3.5-5.5% of said flour, and insoluble dietary fiber having weight percentage in the range of about 9-10% in said flour.

In an embodiment of the present disclosure, there is provided jackfruit flour as described herein, wherein said flour is characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour.

In an embodiment of the present disclosure, there is provided jackfruit flour prepared from fruits or parts thereof, seeds or parts thereof, and strands of jackfruit; flour particle size is about 500 µm, flour moisture content is less than about 8%, and characterized in that said flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour.

In an embodiment of the present disclosure, there is provided a process of preparing jackfruit flour, said process comprising the steps of: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof from said jackfruit; (c) drying fruits or parts thereof, seeds or parts thereof, strands, and combinations thereof to achieve moisture content less than about 8%; and (d) grinding fruits or parts thereof, seeds or parts thereof, strands, and combinations thereof to particle size in the range of 200-1000 µm to obtain jackfruit flour.

In an embodiment of the present disclosure, there is provided a process of preparing jackfruit flour, said process comprising the steps of: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands from said jackfruit; (c) drying fruits or parts thereof, seeds or parts thereof, and strands to achieve moisture content less than about 8%; and (d) grinding fruits or parts thereof, seeds or parts thereof, and strands to particle size in the range of 200-1000 µm to obtain jackfruit flour.

In an embodiment of the present disclosure, there is provided a process of preparing jackfruit flour as described herein, wherein step (c) is carried out at a temperature in the range of about 45-90° C.

In an embodiment of the present disclosure, there is provided a process of preparing jackfruit flour as described herein, wherein step (c) is carried out at a temperature in the range of about 50-75° C.

In an embodiment of the present disclosure, there is provided a process of preparing jackfruit flour as described herein, wherein said method further optionally comprises the step of obtaining jackfruit fruits comprising soluble fiber having weight percentage in the range of about 2-4%; freeze drying said fruits and grinding to particle size in the range of about 200-1000 µm; and adding to jackfruit flour obtained from step (d).

In an embodiment of the present disclosure, there is provided a process of preparing jackfruit flour as described herein, wherein said method further comprises the step of obtaining jackfruit fruits comprising soluble fiber having weight percentage in the range of about 2-4%; freeze drying said fruits and grinding to particle size in the range of about 200-1000 µm; and adding to jackfruit flour obtained from step (d).

In an embodiment of the present disclosure, there is provided a process of preparing jackfruit flour comprising the step of obtaining jackfruit fruits comprising soluble fiber having weight percentage in the range of about 2-4%, and freeze drying said fruits and grinding said fruits as described herein, wherein particle size is in the range of about 300-900 µm.

In an embodiment of the present disclosure, there is provided a process of preparing jackfruit flour comprising the step of obtaining jackfruit fruits comprising soluble fiber having weight percentage in the range of about 2-4%, and freeze drying said fruits and grinding said fruits as described herein, wherein particle size is in the range of about 400-800 µm.

In an embodiment of the present disclosure, there is provided a process of preparing jackfruit flour comprising the step of obtaining jackfruit fruits comprising soluble fiber having weight percentage in the range of about 2-4%, and freeze drying said fruits and grinding said fruits as described herein, wherein particle size is about 500 µm.

In an embodiment of the present disclosure, there is provided a process of preparing jackfruit flour, said process comprising the steps of: (a) obtaining jackfruit, wherein said jackfruit soluble fiber weight percentage in said jackfruit is in the range of about 3-6%; (b) isolating fruits or parts thereof, seeds or parts thereof, strands, and combinations thereof from said jackfruit; (c) drying fruits or parts thereof, seeds or parts thereof, strands, and combinations thereof to achieve moisture content less than about 8%; (d) grinding fruits or parts thereof, seeds or parts thereof, strands, and combinations thereof to particle size in the range of 200-1000 µm to obtain jackfruit flour; (e) obtaining jackfruit fruits comprising soluble fiber having weight percentage in the range of about 2-4%; (f) freeze drying said fruits and grinding to particle size in the range of about 200-1000 µm; and (g) contacting the particles obtained from step (f) with the flour obtained from step (d) to obtain jackfruit flour.

In an embodiment of the present disclosure, there is provided a process of preparing jackfruit flour, said process comprising the steps of: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands from said jackfruit; (c) drying fruits or parts thereof, seeds or parts thereof, and strands to achieve moisture content less than about 8%; (d) grinding fruits or parts thereof, seeds or parts thereof, and strands to particle size in the range of 200-1000 µm to obtain jackfruit flour; (e) obtaining jackfruit fruits comprising soluble fiber having weight percentage in the range of about 2-4%; (f) freeze drying said fruits and grinding to particle size in the range of about 200-1000 µm; and (g) contacting the particles obtained from step (f) with the flour obtained from step (d) to obtain jackfruit flour.

In an embodiment of the present disclosure, there is provided a process of preparing jackfruit flour as described herein, wherein steps (e)-(f) can be carried out in a non-sequential manner with regard to steps (a)-(d).

In an embodiment of the present disclosure, there is provided a process of preparing jackfruit flour as described herein, said process optionally further comprising the step of reconstituting said jackfruit flour with water to obtain reconstituted jackfruit flour having moisture content in the range of about 65-80%.

In an embodiment of the present disclosure, there is provided a process of preparing jackfruit flour as described herein, said process further comprising the step of reconstituting said jackfruit flour with water to obtain reconstituted jackfruit flour having moisture content in the range of about 65-80%.

In an embodiment of the present disclosure, there is provided a process of preparing jackfruit flour, said process comprising the steps of: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof from said jackfruit; (c) drying fruits or parts thereof, seeds or parts thereof, strands, and combinations thereof to achieve moisture content less than about 8%; (d) grinding fruits or parts thereof, seeds or parts thereof, strands, and combinations thereof to particle size in the range of 200-1000 µm to obtain jackfruit flour; (e) reconstituting said jackfruit flour with water to achieve moisture content in the range of about 65-80%.

In an embodiment of the present disclosure, there is provided a process of preparing jackfruit flour, said process comprising the steps of: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands from said jackfruit; (c) drying fruits or parts thereof, seeds or parts thereof, and strands to achieve moisture content less than about 8%; (d) grinding fruits or parts thereof, seeds or parts thereof, and strands to particle size in the range of 200-1000 µm to obtain jackfruit flour; (e) reconstituting said jackfruit flour with water to achieve moisture content in the range of about 65-80%.

In an embodiment of the present disclosure, there is provided a process of preparing jackfruit flour, said process comprising the steps of: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof from said jackfruit; (c) drying fruits or parts thereof, seeds or parts thereof, strands, and combinations thereof to achieve moisture content less than about 8%; (d) grinding fruits or parts thereof, seeds or parts thereof, strands, and combinations thereof to particle size in the range of 200-1000 µm to obtain jackfruit flour; (e) obtaining jackfruit fruits comprising soluble fiber having weight percentage in the range of about 2-4%; (f) freeze drying said fruits and grinding to particle size in the range of about 200-1000 µm; (g) contacting the particles obtained from step (f) with the flour obtained from step (d) to obtain jackfruit flour; and (h) reconstituting said jackfruit flour with water to achieve moisture content in the range of about 65-80%.

In an embodiment of the present disclosure, there is provided a process of preparing jackfruit flour, said process comprising the steps of: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands from said jackfruit; (c) drying fruits or parts thereof, seeds or parts thereof, and strands to achieve moisture content less than about 8%; (d) grinding fruits or parts thereof, seeds or parts thereof, and strands to particle size in the range of 200-1000 µm to obtain jackfruit flour; (e) obtaining jackfruit fruits comprising soluble fiber having weight percentage in the range of about 2-4%; (f) freeze drying said fruits and grinding to particle size in the range of about 200-1000 µm; (g) contacting the particles obtained from step (f) with the flour obtained from step (d) to obtain jackfruit flour; and (h) reconstituting said jackfruit flour with water to achieve moisture content in the range of about 65-80%.

In an embodiment of the present disclosure, there is provided a process of preparing jackfruit flour as described herein, said process optionally further comprising the step of reconstituting said jackfruit flour with water to obtain reconstituted jackfruit flour having moisture content in the range of about 40-60%.

In an embodiment of the present disclosure, there is provided a process of preparing jackfruit flour as described herein, said process further comprising the step of reconstituting said jackfruit flour with water to obtain reconstituted jackfruit flour having moisture content in the range of about 40-60%.

In an embodiment of the present disclosure, there is provided a process of preparing jackfruit flour comprising the step of reconstituting jackfruit flour with water as described herein, wherein said process comprises the step of drying reconstituted jackfruit flour to achieve desired moisture level in the range of 40-60%.

In an embodiment of the present disclosure, there is provided a process of preparing jackfruit flour as described herein, said process further comprising the step of reconstituting said jackfruit flour with water to obtain reconstituted jackfruit flour, and drying said reconstituted jackfruit flour to achieve moisture content in the range of about 40-60%.

In an embodiment of the present disclosure, there is provided a process of preparing jackfruit flour, said process comprising the steps of: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof from said jackfruit; (c) drying fruits or parts thereof, seeds or parts thereof, strands, and combinations thereof to achieve moisture content less than about 8%; (d) grinding fruits or parts thereof, seeds or parts thereof, strands, and combinations thereof to particle size in the range of 200-1000 µm to obtain jackfruit flour; (e) reconstituting said jackfruit flour with water, and drying to achieve moisture content in the range of about 40-60%.

In an embodiment of the present disclosure, there is provided a process of preparing jackfruit flour, said process comprising the steps of: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands from said jackfruit; (c) drying fruits or parts thereof, seeds or parts thereof, and strands to achieve moisture content less than about 8%; (d) grinding fruits or parts thereof, seeds or parts thereof, and strands to particle size in the range of 200-1000 µm to obtain jackfruit flour; (e) reconstituting said jackfruit flour with water, and drying to achieve moisture content in the range of about 40-60%.

In an embodiment of the present disclosure, there is provided a process of preparing jackfruit flour, said process comprising the steps of: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof from said jackfruit; (c) drying fruits or parts thereof, seeds or parts thereof, strands, and combinations thereof to achieve moisture content less than about 8%; (d) grinding fruits or parts thereof, seeds or parts thereof, strands, and combinations thereof to particle size in the range of 200-1000 µm to obtain jackfruit flour; (e) obtaining jackfruit fruits comprising soluble fiber having weight percentage in the range of about 2-4%; (f) freeze drying said fruits and grinding to particle size in the range of about 200-1000 µm; (g) contacting the particles obtained from step (f) with the flour obtained from step (d) to obtain jackfruit flour; and (h) reconstituting said jackfruit flour with water, and drying to achieve moisture content in the range of about 40-60%.

In an embodiment of the present disclosure, there is provided a process of preparing jackfruit flour, said process comprising the steps of: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands from said jackfruit; (c) drying fruits or parts thereof, seeds or parts thereof, and strands to achieve moisture content less than about 8%; (d) grinding fruits or parts thereof, seeds or parts thereof, and strands to particle size in the range of 200-1000 µm to obtain jackfruit flour; (e) obtaining jackfruit fruits comprising soluble fiber having weight percentage in the range of about 2-4%; (f) freeze drying said fruits and grinding to particle size in the range of about 200-1000 µm; (g) contacting the particles obtained from step (f) with the flour obtained from step (d) to obtain jackfruit flour; and (h) reconstituting said jackfruit flour with water, and drying to achieve moisture content in the range of about 40-60%.

In an embodiment of the present disclosure, there is provided a process of preparing jackfruit flour as described herein, said process optionally further comprising the step of reconstituting said jackfruit flour with water to obtain reconstituted jackfruit flour having moisture content less than 8%.

In an embodiment of the present disclosure, there is provided a process of preparing jackfruit flour as described herein, said process further comprising the step of reconstituting said jackfruit flour with water to obtain reconstituted jackfruit flour having moisture content less than 8%.

In an embodiment of the present disclosure, there is provided a process of preparing jackfruit flour comprising the step of reconstituting jackfruit flour with water as described herein, wherein said process comprises the step of drying reconstituted jackfruit flour to achieve desired moisture level of less than about 8%.

In an embodiment of the present disclosure, there is provided a process of preparing jackfruit flour as described herein, said process further comprising the step of reconstituting said jackfruit flour with water to obtain reconstituted jackfruit flour, and drying said reconstituted jackfruit flour to achieve moisture content of less than about 8%.

In an embodiment of the present disclosure, there is provided a process of preparing jackfruit flour, said process comprising the steps of: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof from said jackfruit; (c) drying fruits or parts thereof, seeds or parts thereof, strands, and combinations thereof to achieve moisture content less than about 8%; (d) grinding fruits or parts thereof, seeds or parts thereof, strands, and combinations thereof to particle size in the range of 200-1000 µm to obtain jackfruit flour; (e) reconstituting said jackfruit flour with water, and drying to achieve moisture content of less than about 8%.

In an embodiment of the present disclosure, there is provided a process of preparing jackfruit flour, said process comprising the steps of: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands from said jackfruit; (c) drying fruits or parts thereof, seeds or parts thereof, and strands to achieve moisture content less than about 8%; (d) grinding fruits or parts thereof, seeds or parts thereof, and strands to particle size in the range of 200-1000 µm to obtain jackfruit flour; (e) reconstituting said jackfruit flour with water, and drying to achieve moisture content of less than about 8%.

In an embodiment of the present disclosure, there is provided a process of preparing jackfruit flour, said process comprising the steps of: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof from said jackfruit; (c) drying fruits or parts thereof, seeds or parts thereof, strands, and combinations thereof to achieve moisture content less than about 8%; (d) grinding fruits or parts thereof, seeds or parts thereof, strands, and combinations thereof to particle size in the range of 200-1000 µm to obtain jackfruit flour; (e) obtaining jackfruit fruits comprising soluble fiber having weight percentage in the range of about 2-4%; (f) freeze drying said fruits and grinding to particle size in the range of about 200-1000 µm; (g) contacting the particles obtained from step (f) with the flour obtained from step (d) to obtain jackfruit flour; and (h) reconstituting said jackfruit flour with water, and drying to achieve moisture content of less than about 8%.

In an embodiment of the present disclosure, there is provided a process of preparing jackfruit flour, said process comprising the steps of: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands from said jackfruit; (c) drying fruits or parts thereof, seeds or parts thereof, and strands to achieve moisture content less than about 8%; (d) grinding fruits or parts thereof, seeds or parts thereof, and strands to particle size in the range of 200-1000 µm to obtain jackfruit flour; (e) obtaining jackfruit fruits comprising soluble fiber having weight percentage in the range of about 2-4%; (f) freeze drying said fruits and grinding to particle size in the range of about 200-1000 µm; (g) contacting the particles obtained from step (f) with the flour obtained from step (d) to obtain jackfruit flour; and (h) reconstituting said jackfruit flour with water, and drying to achieve moisture content of less than about 8 %.

In an embodiment of the present disclosure, there is provided a process of preparing jackfruit flour as described herein, wherein flour particle size is in the range of about 300-900 µm.

In an embodiment of the present disclosure, there is provided a process of preparing jackfruit flour as described herein, wherein flour particle size is in the range of about 400-800 µm.

In an embodiment of the present disclosure, there is provided a process of preparing jackfruit flour as described herein, wherein flour particle size of about 500 µm.

In an embodiment of the present disclosure, there is provided a process of preparing jackfruit flour as described herein, wherein flour moisture content is less than about 7%.

In an embodiment of the present disclosure, there is provided a process of preparing jackfruit flour as described herein, wherein flour moisture content is less than about 6%.

In an embodiment of the present disclosure, there is provided a process of preparing jackfruit flour as described herein, wherein flour moisture content is less than about 5%.

In an embodiment of the present disclosure, there is provided a process of preparing jackfruit flour as described herein, wherein said flour is characterized in that said jackfruit flour comprises: (a) total fats having weight percentage in the range of about 0.3-1.5% in said flour, wherein total fats do not comprise detectable levels of saturated fats; (b) proteins having weight percentage in the range of about 7-9% in said flour; and (c) total carbohydrates having weight percentage in the range of about 78-82% in said flour, wherein said carbohydrates comprise dietary fiber having weight percentage in the range of about 12-16% of said flour, and sugars having weight percentage in the range of about 3-11 % of said flour, wherein dietary fiber comprises soluble fiber having weight percentage in the range of about 3-6% of said flour, and insoluble dietary fiber having weight percentage in the range of about 8-12 % in said flour.

In an embodiment of the present disclosure, there is provided a process of preparing jackfruit flour as described herein, wherein said flour is characterized in that said jackfruit flour comprises: (a) total fats having weight percentage in the range of about 0.5-1.2% in said flour, wherein total fats do not comprise detectable levels of saturated fats; (b) proteins having weight percentage in the range of about 7.6-8.7% in said flour; and (c) total carbohydrates having weight percentage in the range of about 79-81% in said flour, wherein said carbohydrates comprise dietary fiber having weight percentage in the range of about 13-15% of said flour, and sugars having weight percentage in the range of about 3-11% of said flour, wherein dietary fiber comprises soluble fiber having weight percentage in the range of about 3.5-5.5% of said flour, and insoluble dietary fiber having weight percentage in the range of about 9-10% in said flour.

In an embodiment of the present disclosure, there is provided a process of preparing jackfruit flour as described herein, wherein said flour is characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour.

In an embodiment of the present disclosure, there is provided a process of preparing jackfruit flour having flour particle size of about 500 µm, flour moisture content of less than about 8%, and characterized in that said flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour, said method comprising: (a) obtaining jackfruit, wherein said jackfruit soluble fiber weight percentage in said jackfruit is about 4%; (b) isolating fruits or parts thereof, seeds or parts thereof, and strands from said jackfruit; (c) drying fruits or parts thereof, seeds or parts thereof, and strands at a temperature in the range of about 50-75° C. to achieve moisture content less than about 8%; and (d) grinding fruits or parts thereof, seeds or parts thereof, and strands to particle size of about 500 µm to obtain jackfruit flour.

In an embodiment of the present disclosure, there is provided a process of preparing jackfruit flour having flour particle size of about 500 µm, flour moisture content in the range of about 65-80%, and characterized in that said flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour, said method comprising: (a) obtaining jackfruit, wherein said jackfruit soluble fiber weight percentage in said jackfruit parts selected from the group consisting of fruits or parts thereof, seeds or parts thereof, and strands is about 4%; (b) isolating fruits or parts thereof, seeds or parts thereof, and strands from said jackfruit; (c) drying fruits or parts thereof, seeds or parts thereof, and strands at a temperature in the range of about 50-75° C. to achieve moisture content less than about 8%; (d) grinding fruits or parts thereof, seeds or parts thereof, and strands to particle size of about 500 µm to obtain jackfruit flour; and (e) reconstituting jackfruit flour with water to achieve moisture content in the range of about 65-80%.

In an embodiment of the present disclosure, there is provided a process of preparing jackfruit flour having flour particle size of about 500 µm, flour moisture content in the range of about 40-60%, and characterized in that said flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6 % of said flour, wherein dietary fiber comprises soluble fiber having weight percentage of about 4% of said flour, and insoluble dietary fiber having weight percentage of about 9.7% in said flour, said method comprising: (a) obtaining jackfruit, wherein said jackfruit soluble fiber weight percentage in said jackfruit parts of fruits or parts thereof, seeds or parts thereof, and strands is about 4%; (b) isolating fruits or parts thereof, seeds or parts thereof, and strands from said jackfruit; (c) drying fruits or parts thereof, seeds or parts thereof, and strands at a temperature in the range of about 50-75° C. to achieve moisture content less than about 8%; (d) grinding fruits or parts thereof, seeds or parts thereof, and strands to particle size of about 500 µm to obtain jackfruit flour; and (e) reconstituting jackfruit flour with water, and drying to achieve moisture content in the range of 40-60%.

In an embodiment of the present disclosure, there is provided a process of preparing jackfruit flour having flour particle size of about 500 µm, flour moisture content less than about 8%, and characterized in that said flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour, said method comprising: (a) obtaining jackfruit, wherein said jackfruit soluble fiber weight percentage in said jackfruit parts of fruits or parts thereof, seeds or parts thereof, and strands is about 4%; (b) isolating fruits or parts thereof, seeds or parts thereof, and strands from said jackfruit; (c) drying fruits or parts thereof, seeds or parts thereof, and strands at a temperature in the range of about 50-75° C. to achieve moisture content less than about 8%; (d) grinding fruits or parts thereof, seeds or parts thereof, and strands to particle size of about 500 µm to obtain jackfruit flour; and (e) reconstituting jackfruit flour with water, and drying to achieve moisture content of less than 8%.

In an embodiment of the present disclosure, there is provided a process of preparing jackfruit flour having flour particle size of about 500 µm, flour moisture content of less than about 8%, and characterized in that said flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour, said method comprising: (a) obtaining jackfruit, wherein said jackfruit soluble fiber weight percentage in said jackfruit parts of fruits or parts thereof, seeds or parts thereof, and strands is about 4%; (b) isolating fruits or parts thereof, seeds or parts thereof, and strands from said jackfruit; (c) drying fruits or parts thereof, seeds or parts thereof, and strands at a temperature in the range of about 50-75° C. to achieve moisture content less than about 8%; (d) grinding fruits or parts thereof, seeds or parts thereof, and strands to particle size of about 500 µm; (e) obtaining jackfruit fruits comprising soluble fiber having weight percentage in the range of about 2-4%; (f) freeze drying said fruits and grinding to particle size of about 500 µm; and (g) contacting the particles obtained from step (f) with the flour obtained from step (d) to obtain jackfruit flour.

In an embodiment of the present disclosure, there is provided a process of preparing jackfruit flour having flour particle size of about 500 µm, flour moisture content in the range of about 65-80%, and characterized in that said flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7 % in said flour, said method comprising: (a) obtaining jackfruit, wherein said jackfruit soluble fiber weight percentage in said jackfruit parts of fruits or parts thereof, seeds or parts thereof, and strands is about 4%; (b) isolating fruits or parts thereof, seeds or parts thereof, and strands from said jackfruit; (c) drying fruits or parts thereof, seeds or parts thereof, and strands at a temperature in the range of about 50-75° C. to achieve moisture content less than about 8%; (d) grinding fruits or parts thereof, seeds or parts thereof, and strands to particle size of about 500 µm; (e) obtaining jackfruit fruits comprising soluble fiber having weight percentage in the range of about 2-4%; (f) freeze drying said fruits and grinding to particle size in the range of about 200-1000 µm; (g) contacting the particles obtained from step (f) with the flour obtained from step (d) to obtain jackfruit flour; and (i) reconstituting jackfruit flour with water to achieve moisture content in the range of about 65-80%.

In an embodiment of the present disclosure, there is provided a process of preparing jackfruit flour having flour particle size of about 500 µm, flour moisture content in the range of about 40-60%, and characterized in that said flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour, said method comprising: (a) obtaining jackfruit, wherein said jackfruit soluble fiber weight percentage in said jackfruit parts of fruits or parts thereof, seeds or parts thereof, and strands is about 4%; (b) isolating fruits or parts thereof, seeds or parts thereof, and strands from said jackfruit; (c) drying fruits or parts thereof, seeds or parts thereof, and strands at a temperature in the range of about 50-75° C. to achieve moisture content less than about 8%; (d) grinding fruits or parts thereof, seeds or parts thereof, and strands to particle size of about 500 µm; (e) obtaining jackfruit fruits comprising soluble fiber having weight percentage in the range of about 2-4%; (f) freeze drying said fruits and grinding to particle size in the range of about 200-1000 µm; (g) contacting the particles obtained from step (f) with the flour obtained from step (d) to obtain jackfruit flour; and (i) reconstituting jackfruit flour with water, and drying to achieve moisture content in the range of about 40-60 %.

In an embodiment of the present disclosure, there is provided a process of preparing jackfruit flour having flour particle size of about 500 µm, flour moisture content less than about 8%, and characterized in that said flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour, said method comprising: (a) obtaining jackfruit, wherein said jackfruit soluble fiber weight percentage in said jackfruit parts of fruits or parts thereof, seeds or parts thereof, and strands is about 4%; (b) isolating fruits or parts thereof, seeds or parts thereof, and strands from said jackfruit; (c) drying fruits or parts thereof, seeds or parts thereof, and strands at a temperature in the range of about 50-75° C. to achieve moisture content less than about 8%; (d) grinding fruits or parts thereof, seeds or parts thereof, and strands to particle size of about 500 µm; (e) obtaining jackfruit fruits comprising soluble fiber having weight percentage in the range of about 2-4%; (f) freeze drying said fruits and grinding to particle size of about 500 µm; (g) contacting the particles obtained from step (f) with the flour obtained from step (d) to obtain jackfruit flour; and (i) reconstituting jackfruit flour with water, and drying to achieve moisture content of less than about 8%.

In an embodiment of the present disclosure, there is provided a process of preparing jackfruit flour as described herein, wherein said process may include addition of rind or core of jackfruit in quantities insufficient to alter binding properties.

In an embodiment of the present disclosure, there is provided a process of preparing jackfruit flour as described herein, wherein said process may include addition of rind or core of jackfruit in quantities insufficient to alter taste profile.

In an embodiment of the present disclosure, there is provided a process of preparing jackfruit flour as described herein, wherein said process may include addition of rind or core of jackfruit in quantities insufficient to alter nutritional characteristics.

In an embodiment of the present disclosure, there is provided a process of preparing jackfruit flour from fruits or parts thereof, seeds or parts thereof, and strands as described herein, wherein in step (a), the soluble fiber content in the range of about 3-6% is of fruits or parts thereof, seeds or parts thereof, and strands.

In an embodiment of the present disclosure, there is provided a fortified flour composition comprising: (a) at least one flour; and (b) jackfruit flour as described herein, wherein flour to jackfruit flour w/w ratio is in the range of 9:1-1:99.

In an embodiment of the present disclosure, there is provided a fortified flour composition as described herein, wherein flour to jackfruit flour w/w ratio is about 3:7.

In an embodiment of the present disclosure, there is provided a fortified flour composition as described herein, wherein jackfruit flour weight percentage in said composition is in the range of about 10-99%.

In an embodiment of the present disclosure, there is provided a fortified flour composition as described herein, wherein jackfruit flour weight percentage in said composition is about 30%.

In an embodiment of the present disclosure, there is provided a fortified flour composition as described herein, wherein said flour is obtained from wheat, barley, rye, rice, millet, oat, acorn, amaranth, banana, buckwheat, cassava, chestnut, chickpea, coconut, maize, cornstarch, flax, plea, potato, sorghum, tapioca, teff, and combinations thereof.

In an embodiment of the present disclosure, there is provided a fortified flour composition as described herein, wherein said flour is obtained from wheat.

In an embodiment of the present disclosure, there is provided a fortified flour composition as described herein, optionally further comprising at least one fortifier selected from the group consisting of vitamins, minerals, whole vegetable extracts or extracts of parts thereof, gums and combinations thereof.

In an embodiment of the present disclosure, there is provided a fortified flour composition as described herein, further comprising at least one fortifier selected from the group consisting of vitamins, minerals, whole vegetable extracts or extracts of parts thereof, gums and combinations thereof.

In an embodiment of the present disclosure, there is provided a fortified flour composition as described herein, wherein said gums can be gluten, guar gum, xanthan gum, and combinations thereof.

In an embodiment of the present disclosure, there is provided a fortified flour composition comprising: (a) wheat flour; and (b) jackfruit flour having moisture content of less than about 8%, and particle size of about 500 µm, characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour; wherein jackfruit flour to wheat w/w ratio is 3:7.

In an embodiment of the present disclosure, there is provided a fortified flour composition comprising: (a) wheat flour; and (b) jackfruit flour having moisture content of less than about 8%, and particle size of about 500 µm, characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour; wherein jackfruit flour weight percentage is 30%.

In an embodiment of the present disclosure, there is provided jackfruit flour as described herein, for use as a meat additive.

In an embodiment of the present disclosure, there is provided jackfruit flour for use as a meat additive as described herein, wherein jackfruit flour weight percentage is in the range of about 10-99%.

In an embodiment of the present disclosure, there is provided jackfruit flour for use as a meat additive as described herein, wherein jackfruit flour weight percentage is in the range of about 20-80%.

In an embodiment of the present disclosure, there is provided jackfruit flour for use as a meat additive as described herein, wherein jackfruit flour weight percentage is in the range of about 30-70%.

In an embodiment of the present disclosure, there is provided jackfruit flour for use as a meat additive as described herein, wherein jackfruit flour weight percentage is about 30%.

In an embodiment of the present disclosure, there is provided jackfruit flour having moisture content of less than about 8%, and particle size of about 500 µm, characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour; for use as a meat additive, wherein jackfruit flour weight percentage is about 30%.

In an embodiment of the present disclosure, there is provided jackfruit flour as described herein, for use as a meat substitute.

In an embodiment of the present disclosure, there is provided jackfruit flour for use as a meat substitute as described herein, wherein jackfruit flour weight percentage is in the range of about 10-99%.

In an embodiment of the present disclosure, there is provided jackfruit flour for use as a meat substitute as described herein, wherein jackfruit flour weight percentage is in the range of about 20-80%.

In an embodiment of the present disclosure, there is provided jackfruit flour for use as a meat substitute as described herein, wherein jackfruit flour weight percentage is in the range of about 30-70%.

In an embodiment of the present disclosure, there is provided jackfruit flour for use as a meat substitute as described herein, wherein jackfruit flour weight percentage is about 30%.

In an embodiment of the present disclosure, there is provided jackfruit flour having moisture content of less than about 8%, and particle size of about 500 µm, characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7 % in said flour; for use as a meat substitute, wherein jackfruit flour weight percentage is about 30%.

In an embodiment of the present disclosure, there is provided jackfruit flour as described herein, for use as a flour additive.

In an embodiment of the present disclosure, there is provided jackfruit flour for use as a flour additive as described herein, wherein said flour is obtained from the group consisting of wheat, barley, rye, rice, millet, oat, acorn, amaranth, banana, buckwheat, cassava, chestnut, chickpea, coconut, maize, cornstarch, flax, plea, potato, sorghum, tapioca, teff, and combinations thereof.

In an embodiment of the present disclosure, there is provided jackfruit flour for use as a flour additive as described herein, wherein said flour is obtained from wheat.

In an embodiment of the present disclosure, there is provided jackfruit flour for use as a flour additive as described herein, wherein jackfruit flour weight percentage is in the range of about 10-99%.

In an embodiment of the present disclosure, there is provided jackfruit flour for use as a flour additive as described herein, wherein jackfruit flour weight percentage is in the range of about 20-80%.

In an embodiment of the present disclosure, there is provided jackfruit flour for use as a flour additive as described herein, wherein jackfruit flour weight percentage is in the range of about 30-70%.

In an embodiment of the present disclosure, there is provided jackfruit flour for use as a flour additive as described herein, wherein jackfruit flour weight percentage is about 30%.

In an embodiment of the present disclosure, there is provided jackfruit flour having moisture content of less than about 8%, and particle size of about 500 µm, characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour; for use as a wheat flour additive, wherein jackfruit flour weight percentage is about 30%.

In an embodiment of the present disclosure, there is provided jackfruit flour as described herein, for use as a flour substitute.

In an embodiment of the present disclosure, there is provided jackfruit flour for use as a flour substitute as described herein, wherein said flour is obtained from the group consisting of wheat, barley, rye, rice, millet, oat, acorn, amaranth, banana, buckwheat, cassava, chestnut, chickpea, coconut, maize, cornstarch, flax, plea, potato, sorghum, tapioca, teff, and combinations thereof.

In an embodiment of the present disclosure, there is provided jackfruit flour for use as a flour substitute as described herein, wherein said flour is obtained from wheat.

In an embodiment of the present disclosure, there is provided jackfruit flour for use as a flour substitute as described herein, wherein jackfruit flour weight percentage is in the range of about 10-99%.

In an embodiment of the present disclosure, there is provided jackfruit flour for use as a flour substitute as described herein, wherein jackfruit flour weight percentage is in the range of about 20-80%.

In an embodiment of the present disclosure, there is provided jackfruit flour for use as a flour substitute as described herein, wherein jackfruit flour weight percentage is in the range of about 30-70%.

In an embodiment of the present disclosure, there is provided jackfruit flour for use as a flour substitute as described herein, wherein jackfruit flour weight percentage is about 30%.

In an embodiment of the present disclosure, there is provided jackfruit flour having moisture content of less than about 8%, and particle size of about 500 µm, characterized in that said jackfruit flour comprises: (a) total fats having weight percentage of about 0.5 % in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour; for use as a wheat flour substitute, wherein jackfruit flour weight percentage is about 30%.

In an embodiment of the present disclosure, there is provided jackfruit flour as described herein, for use as a total meat substitute.

In an embodiment of the present disclosure, there is provided jackfruit flour having moisture content of less than about 8%, and particle size of about 500 µm, characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour; for use as total meat substitute.

In an embodiment of the present disclosure, there is provided jackfruit flour as described herein, for use as a total flour substitute.

In an embodiment of the present disclosure, there is provided jackfruit flour as for use as a total flour substitute as described herein, wherein said flour is obtained from the group consisting of wheat, barley, rye, rice, millet, oat, acorn, amaranth, banana, buckwheat, cassava, chestnut, chickpea, coconut, maize, cornstarch, flax, plea, potato, sorghum, tapioca, teff, and combinations thereof.

In an embodiment of the present disclosure, there is provided jackfruit flour as for use as a total wheat flour substitute.

In an embodiment of the present disclosure, there is provided jackfruit flour having moisture content of less than about 8%, and particle size of about 500 µm, characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour; for use as total wheat flour substitute.

In an embodiment of the present disclosure, there is provided a method of reducing the glycemic load, reducing calorie amount, and/or increasing fiber content of food, said method comprising the steps of: (a) obtaining jackfruit flour as described herein; and contacting said jackfruit flour with food, wherein jackfruit flour weight percentage is in the range of about 10-99%.

In an embodiment of the present disclosure, there is provided a method of reducing the glycemic load, reducing calorie amount, and increasing fiber content of food, said method comprising the steps of: (a) obtaining jackfruit flour having moisture content of less than about 8%, and particle size of about 500 µm, characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour; and (b) contacting said jackfruit flour with food, wherein jackfruit flour weight percentage is in the range of about 10-99%.

In an embodiment of the present disclosure, there is provided a method of reducing the glycemic load, reducing calorie amount, and increasing fiber content of food, said method comprising the steps of: (a) obtaining fortified flour composition as described herein; and contacting said fortified flour composition with food, wherein fortified flour weight percentage is in the range of about 10-99%.

In an embodiment of the present disclosure, there is provided a method of reducing the glycemic load, reducing calorie amount, and increasing fiber content of food, said method comprising the steps of: (a) obtaining a fortified flour composition comprising: (i) wheat flour; and (ii) jackfruit flour having moisture content of less than about 8%, and particle size of about 500 µm,characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour, wherein wheat flour to jackfruit flour w/w ratio is in the range of 91:-1:99; and (b) contacting said fortified flour with food, wherein fortified flour weight percentage is in the range of about 10-99%.

In an embodiment of the present disclosure, there is provided a method of reducing the glycemic load, reducing calorie amount, and increasing fiber content of food, said method comprising the steps of: (a) obtaining a fortified flour composition comprising: (i) wheat flour; and (ii) jackfruit flour having moisture content of less than about 8%, and particle size of about 500 µm,characterized in that said jackfruit flour comprises: (a) total fats having weight percentage of about 0.5% in said flour, wherein total fats do not comprise detectable levels of saturated fats; (b) proteins having weight percentage of about 8% in said flour; and (c) total carbohydrates having weight percentage of about 80% in said flour, wherein said carbohydrates comprise dietary fiber having weight percentage of about 13.7% of said flour, and sugars having weight percentage of about 6% of said flour, wherein dietary fiber comprises soluble fiber having weight percentage of about 4% of said flour, and insoluble dietary fiber having weight percentage of about 9.7% in said flour, wherein wheat flour to jackfruit flour w/w ratio is 7:3; and (b) contacting said fortified flour with food, wherein fortified flour weight percentage is in the range of about 10-99%.

In an embodiment of the present disclosure, there is provided a composition comprising jackfruit extract prepared from jackfruit fruits or parts thereof, seeds or parts thereof, strands, and combinations thereof, wherein said composition moisture content is in the range of about 65-80%.

In an embodiment of the present disclosure, there is provided a composition comprising jackfruit extract having moisture content in the range of about 65-80% as described herein, wherein said extract is prepared from jackfruit fruits or parts thereof, seeds or parts thereof, and strands.

In an embodiment of the present disclosure, there is provided a composition comprising jackfruit extract prepared from jackfruit fruits or parts thereof, seeds or parts thereof, and strands, wherein said composition moisture content is in the range of about 65-80%.

In an embodiment of the present disclosure, there is provided a method of preparing a composition comprising jackfruit extract having moisture content in the range of about 65-80% prepared from jackfruit fruits or parts thereof, seeds or parts thereof, strands, and combinations thereof, said method comprising: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof; (c) grinding isolated fruits or parts thereof, seeds or parts thereof, strands, and combinations thereof to obtain a composition.

In an embodiment of the present disclosure, there is provided a method of preparing a composition comprising jackfruit extract having moisture content in the range of about 65-80% prepared from jackfruit fruits or parts thereof, seeds or parts thereof, and strands, said method comprising: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands; (c) grinding isolated fruits or parts thereof, seeds or parts thereof, and strands to obtain a composition.

In an embodiment of the present disclosure, there is provided a composition comprising jackfruit extract prepared from jackfruit fruits or parts thereof, seeds or parts thereof, strands, and combinations thereof, wherein said composition moisture content is in the range of about 40-60%.

In an embodiment of the present disclosure, there is provided a composition comprising jackfruit extract having moisture content in the range of 40-60% as described herein, wherein said extract is prepared from jackfruit fruits or parts thereof, seeds or parts thereof, and strands.

In an embodiment of the present disclosure, there is provided a composition comprising jackfruit extract prepared from jackfruit fruits or parts thereof, seeds or parts thereof, and strands, wherein said composition moisture content is in the range of about 40-60%.

In an embodiment of the present disclosure, there is provided a method of preparing a composition comprising jackfruit extract having moisture content in the range of about 40-60% prepared from jackfruit fruits or parts thereof, seeds or parts thereof, strands, and combinations thereof, said method comprising: (a) obtaining jackfruit, wherein said jackfruit soluble fiber weight percentage in said jackfruit parts of fruits or parts thereof, seeds or parts thereof, strands, and combinations thereof is in the range of about 3-6%; (b) isolating fruits or parts thereof, seeds or parts thereof, strands, and combinations thereof; (c) grinding isolated fruits or parts thereof, seeds or parts thereof, strands, and combinations thereof, and drying to obtain a composition.

In an embodiment of the present disclosure, there is provided a method of preparing a composition comprising jackfruit extract having moisture content in the range of about 40-60% prepared from jackfruit fruits or parts thereof, seeds or parts thereof, and strands, said method comprising: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands; (c) grinding isolated fruits or parts thereof, seeds or parts thereof, and strands, and drying to obtain a composition.

In an embodiment of the present disclosure, there is provided a composition comprising jackfruit extract prepared from jackfruit fruits or parts thereof, seeds or parts thereof, strands, and combinations thereof, wherein said composition moisture content is less than about 8%.

In an embodiment of the present disclosure, there is provided a composition comprising jackfruit extract having moisture content of less than about 8% as described herein, wherein said extract is prepared from jackfruit fruits or parts thereof, seeds or parts thereof, and strands.

In an embodiment of the present disclosure, there is provided a composition comprising jackfruit extract prepared from jackfruit fruits or parts thereof, seeds or parts thereof, and strands, wherein said composition moisture content is less than about 8%.

In an embodiment of the present disclosure, there is provided a method of preparing a composition comprising jackfruit extract having moisture content of less than about 8% prepared from jackfruit fruits or parts thereof, seeds or parts thereof, strands, and combinations thereof, wherein said composition is prepared by: (a) obtaining jackfruit, wherein said jackfruit soluble fiber weight percentage in said jackfruit parts selected from the group consisting of fruits or parts thereof, seeds or parts thereof, strands, and combinations thereof is in the range of about 3-6%; (b) isolating fruits or parts thereof, seeds or parts thereof, strands, and combinations thereof; (c) grinding isolated fruits or parts thereof, seeds or parts thereof, strands, and combinations thereof to obtain a composition.

In an embodiment of the present disclosure, there is provided a method of preparing a composition comprising jackfruit extract having moisture content of less than about 8% prepared from jackfruit fruits or parts thereof, seeds or parts thereof, and strands, said method comprising: (a) obtaining jackfruit, wherein said jackfruit soluble fiber weight percentage in said jackfruit parts of fruits or parts thereof, seeds or parts thereof, and strands is in the range of about 3-6%; (b) isolating fruits or parts thereof, seeds or parts thereof, and strands; (c) grinding isolated fruits or parts thereof, seeds or parts thereof, and strands, and drying to obtain a composition.

In an embodiment of the present disclosure, there is provided a method of preparing a composition as described herein, wherein said drying is carried out at a temperature in the range of 45-90° C.

In an embodiment of the present disclosure, there is provided a method of preparing a composition as described herein, wherein said drying is carried out at a temperature in the range of 50-75° C.

In an embodiment of the present disclosure, there is provided a composition as described herein, optionally further comprising suitable additives.

In an embodiment of the present disclosure, there is provided a composition as described herein, further comprising suitable additives.

In an embodiment of the present disclosure, there is provided a composition comprising suitable additives as described herein, wherein said additives can be any ingredient to enhance the flavor, color, stability, or durability of said composition.

In an embodiment of the present disclosure, there is provided a composition comprising suitable additives as described herein, wherein said additives can be preservatives.

In an embodiment of the present disclosure, there is provided a composition comprising suitable additives as described herein, wherein said additives can be food grade colors.

In an embodiment of the present disclosure, there is provided a composition comprising jackfruit extract, wherein said composition moisture content is in the range of about 65-80% as described herein, wherein said composition is in the form of a batter.

In an embodiment of the present disclosure, there is provided a composition comprising jackfruit extract, wherein said composition moisture content is in the range of about 40-60% as described herein, wherein said composition is in the form of a dough.

In an embodiment of the present disclosure, there is provided a composition comprising jackfruit extract, wherein said composition moisture content is less than about 8% as described herein, wherein said composition is in the form of a dried dough.

Although the subject matter has been described in considerable detail with reference to certain preferred embodiments thereof, other embodiments are possible.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein. It is to be understood that this disclosure is not limited to particular methods, and experimental conditions described, as such methods and conditions may vary.

### Example 1 Jackfruit Flour Nutrition Profile

In order to select jackfruit or parts thereof which are well suited to serve as starting raw materials for preparing jackfruit flour, various parts of jackfruit were tested for soluble fiber (pectin) content. Pectin is an important factor when preparing flour as it provides binding properties to the flour during food preparation. Sugar levels, and total fiber levels are also important as jackfruit flour is suggested as a healthy alternative offering superior benefits such as high fiber content, low sugar, and providing increased satiety levels.

Firstly, the pectin levels in various parts of the fruit viz., carpel, perigone, rind, core, and seeds were estimated. It has been previously shown that pectin levels in said parts in firmflesh jackfruit at harvest contain 2.46%, 3.38%, 5.12%, 5.62% and 0.58% pectin respectively, which upon ripening decrease to 2%, 3.03%, 4.65%, 4.01%, and 0.49% respectively. In softflesh jackfruit at harvest, pectin content is 2.71%, 3.52%, 5.24%, 5.75%, and 0.7% respectively, which at ripening decreases to 2.06%, 3.24%, 4.59%, 4.45, and 0.6% respectively (www.researchjournal.co.in/online/TAJH/TAJH%206(2)/6 A-536-537.pdf). With increase in time from harvest, as the fruit matures, more pectin is converted to sugars (it can go up to as high as 56 g with maturity time progression). Jackfruit parts for preparation of flour were physically assessed and selected based on maturity level when the fruit does not have a sweet taste, has a neutral aroma, and has hard seeds which will slip out of the fruit when cut by half. The selection is further validated by ascertaining the soluble fiber levels (pectin).

In the present instance, two separate jackfruit flours were prepared, one using the seeds, fruits, and strands, while the second one further comprised the rind and the core. It is to be noted that, it is possible, and contemplated that in the flour prepared from fruits (or parts thereof), seeds (or parts thereof), and strands, there may be some amount of rind and/or core present. It is also to be mentioned that the presence of rind or core may be in amounts insufficient to significantly alter the binding, taste or nutritional characteristics of the jackfruit flour otherwise prepared majorly from fruits or parts thereof, seeds or parts thereof, and strands. Various nutritional parameters were measured to deduce the value of the flour compositions. Table 1 below depicts the nutritional values of 3 different batches of jackfruit flour prepared from fruits, seeds, and strands.

TABLE 1

| Nutrition (100 g) | Batch 1 | Batch 2 | Batch 3 |
|---|---|---|---|
| Energy (kcal) | 366.2 | 362.2 | 353.4 |
| Total carb (g) | 79 | 80.4 | 78.2 |
| Total diet fiber (g) | 13.4 | 15.1 | 13 |
| Soluble fiber (g) | 3.6 | 5.3 | 3.4 |
| Insoluble fiber (g) | 9.8 | 9.8 | 9.6 |
| Sugar (g) | 3.2 | 10.8 | 4.4 |
| Protein (g) | 7.6 | 8.7 | 7.9 |

Table 2 below depicts the nutritional values of the flour obtained from fruits, seeds, and strands (mean of the 3 batches as shown in Table 1), and flour obtained from fruits, seeds, strands, rind, and core.

TABLE 2

| Nutrition (100 g) | Fruits, seeds, strands | Fruits, seeds, strands, rind, and core |
|---|---|---|
| Energy (kcal) | 360 | 374.3 |
| Total carb (g) | 80 | 84.5 |
| Total diet fiber (g) | 13.7 | 13.1 |
| Soluble fiber (g) | 4 | 3.3 |
| Insoluble fiber (g) | 9.7 | 9.8 |
| Sugar (g) | 6 | 7.1 |
| Protein (g) | 8 | 6.3 |

As seen from Table 2, the flour prepared from fruits, seeds, and strands only has higher content of soluble fiber (20% more), less sugars (about 13% less), less carbs (about 5% less), and more protein (27% more). Importantly, the jackfruit flour made from rind and core has a bitter taste, and low binding capacity. It can also be seen that the soluble fiber to insoluble fiber w/w ratio is about 3:7 in the flour prepared from fruits, seeds, and strands, while the ratio is 1:3 in the case of flour prepared from fruits, seeds, strands, rind, and core. These data suggest that the flour prepared from fruits, seeds, and strands is better suited for the intended purposes.

In accordance with the disclosure, flour was also prepared from fruits alone using freeze drying procedure, nutrition profile of which is provided in Table 3 below.

TABLE 3

| Nutrition (100 g) | Fruits |
|---|---|
| Energy (kcal) | 384.7 |
| Total carb (g) | 91 |
| Total diet fiber (g) | 6.5 |
| Soluble fiber (g) | 2.6 |
| Insoluble fiber (g) | 3.9 |
| Sugar (g) | 10.2 |
| Protein (g) | 3.6 |

As seen from Table 3, while the flour prepared from freeze dried fruit part only has lesser protein and dietary fibers, importantly, the weight ratio of soluble to insoluble dietary fiber is 2:3, suggesting that jackfruit flour prepared from fruits alone have lower insoluble fiber per unit, compared to the flour compositions of Table 2. It is envisioned that the flour prepared from fruits alone can be used to reduce the insoluble fiber content and increase binding of flour prepared from fruits, seeds, and strands without significantly affecting any of the other nutritional parameters.

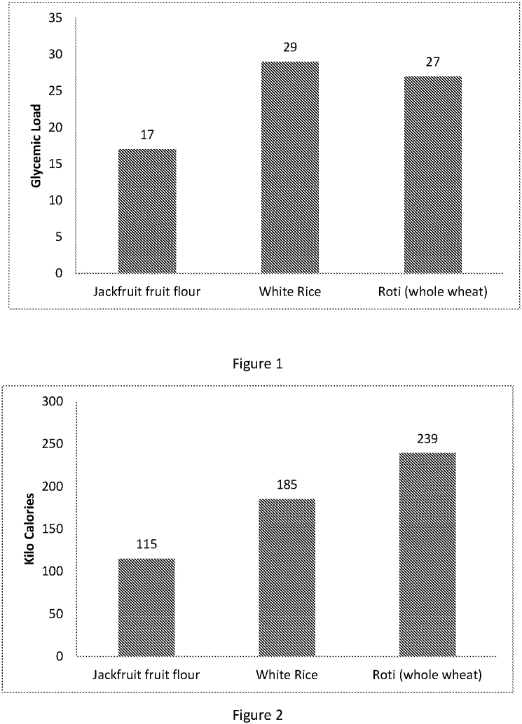

In order to further establish the utility of jackfruit flour as an additive or substitute, the glycemic load (the glycemic load (GL) of food is a number that estimates how much the food will raise a person’s blood glucose level after eating it. One unit of glycemic load approximates the effect of consuming one gram of glucose) of raw jackfruit (1 serving=30 g dry weight) was compared with that of white rice (1 serving=50 g dry weight), and whole wheat (2 rotis, 60 g dry weight) (1 serving). As shown in FIG. 1, for a single serving of jackfruit flour of the present invention, compared to a single serving of white rice or 2 rotis prepared from whole wheat (single serving), the glycemic load of jackfruit flour is 17, which is about 60% less than that of whole wheat roti, and about 70% less than that of white rice. FIG. 2 shows the calorie level of jackfruit flour in comparison to white rice, and whole wheat rotis. As inferred from FIG. 2, jackfruit flour (1 serving) has lowest calorie compared to white rice (1 serving) or 2 rotis (whole wheat) (1 serving). 1 serving of jackfruit flour has about 30% less calories than 1 serving of white rice, while it is about 55% less than of 1 serving of whole wheat flour (2 rotis). Further, as seen from Table 4 below, the fiber content of jackfruit flour is significantly higher than that of whole wheat flour (about 2 fold more per gram) or white rice (about 3 fold more per gram) (1 serving each). These data indicate that jackfruit flour is a superior alternative to wheat flour or rice for use in preparation of food products, and offers superior health benefits, particularly in satiety control, increased fiber content, and weight management or reduction. The low glycemic load is also useful for diabetic people looking for flour alternatives.

TABLE 4

| | | | |
|---|---|---|---|
| 1 serving | Jackfruit flour | White rice | Roti (whole wheat) |
| Dry weight | 30 g | 50 g | 60 g |
| Energy (kcal) | 115 | 185 | 238.8 |
| Fiber | 1.95 g | 1 g | 1.8 g |
| Carb | 25 g | 40 g | 43.8 g |
| Glycemic load | 17 | 29 | 27 |
| Source* | SUGiRS study | Livestrong.com | |

In order to further ascertain and establish the utility and functionality of jackfruit flour as a suitable additive or substitute, the glycemic index of jackfruit was evaluated. The glycemic index (GI) method was developed in order to rank equal carbohydrate portions of different foods according to the extend to which they increase blood glucose levels after being eaten (Jenkins et al, American Journal of Clinical Nutrition, 1981, 34, 362-366). Foods with high GI value contain rapidly digested carbohydrate, which produces a rapid and large rise and fall in the level of blood glucose. The World Health Organisation released a consensus report stating that food labels should provide the food’s total digestible carbohydrate content and its GI value, in order to help people select foods that will reduce the overall glycemic impact of their diet (Joint FAO/WHO Report, 1998, FAO Food and Nutrition, Paper 66). It has been shown that high GI diets enhance body fat storage to a greater extent than equal calorie low GI diets in healthy people, which is likely to reflect the greater insulin secretion and lower satiety associated with high GI foods (Bouche et al., Diabetes Care, 2002, 25, 822-828).

In the present instance, a study was carried out to measure the glycemic index (GI) value of jackfruit flour (prepared by freeze drying jackfruit fruit flesh), using pure glucose sugar as a reference food. The study was carried out by Sydney University’s Glycemic Index Research Service (SUGiRS), the results of which are provided and discussed below.

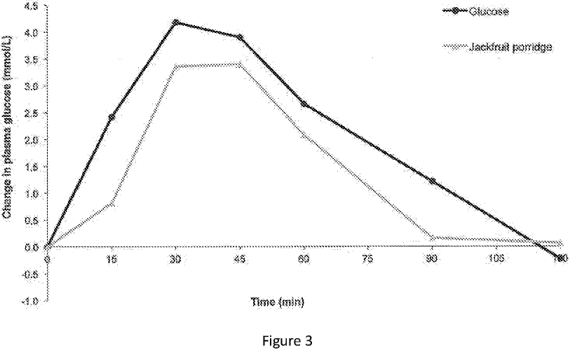

As seen in FIG. 3, which depicts the average 2 hour plasma glucose response curves for 50 g carbohydrate portions prepared in water, jackfruit flour produced a moderate plateau shaped peak plasma glucose concentration between 30-45 minutes followed by a steady decline in glycemia between 45-120 minutes. Glucose in contrast, produced a rapid initial rise in plasma glucose to a high peak concentration at 30 minutes and a greater overall glycemic response. The plasma glucose response produced by jackfruit flour returned to baseline concentration by 90 minutes. The mean GI values for jackfruit flour and glucose (reference) is shown below in Table 5. It is also to be noted that the GL value for jackfruit flour prepared from fruits alone is 17.

TABLE 5

| Test food | GI value | GI category |
|---|---|---|
| Jackfruit flour | 65±5 | Medium GI |
| Glucose sugar | 100 | High GI |

Using glucose as a reference food (GI=100), , foods with a GI value less than 55 are considered to be low GI foods (Brand-Miller et al., The New Glucose Revolution, 2002; Atkinson et al., Diabetes Care, 2008, 31, 2281-2283). The jackfruit flour of the instant disclosure is placed in the medium GI category, which would make it suitable for consumption in controlled amounts by people with diabetes for instance. As the fiber content of jackfruit flour prepared from fruits, seeds, and strands has higher fiber content, it is expected that the GL value would be lower than that of jackfruit flour prepared from fruits alone (17).

These data further support the assertion that jackfruit flour is a suitable and superior alternative or substitute to other flours, including starches from various sources. Table 6 below depicts the nutrition profile of various batches of jackfruit flour prepared from fruits, seeds, and strands, compared to flour prepared from fruits alone.

TABLE 6

| Nutrition (100 g) | GLTested Fruits GL= 17 | Fruits, seeds, strands Batch 1 | Fruits, seeds, strands Batch 2 | Fruits, seeds, strands Batch 3 |
|---|---|---|---|---|
| Energy (kcal) | 384.7 | 366.2 | 362.2 | 353.4 |
| Total carb (g) | 91 | 79 | 80.4 | 78.2 |
| Total diet fiber (g) | 6.5 | 13.4 | 15.1 | 13 |
| Soluble fiber (g) | 2.6 | 3.6 | 5.3 | 3.4 |
| Insoluble fiber (g) | 3.9 | 9.8 | 9.8 | 9.6 |
| Sugar (g) | 10.2 | 3.2 | 10.8 | 4.4 |
| Protein (g) | 3.6 | 7.6 | 8.7 | 7.9 |

### Example 2 Preparation of Jackfruit Flour

Jackfruits based on physical and biochemical assessment were selected and the rind and core were discarded. The fruits, seeds, and strands were collected and cut into chunks to aid drying. The pieces were subjected to continuous air drying by blowing hot air using conventional processes known in the art. Briefly, the jackfruit pieces were placed on a continuous multi pass conveyor at the top level , and hot air at about 75-90° C. was introduced at the top. It was ascertained that a temperature gradient is evident between the top and the bottom layers, wherein, the gradient can be between 90-45° C., more preferably from 75-50° C. The jackfruit pieces were extracted once the moisture content dropped below 8%. Any other process can also be used to dry the jackfruit pieces. Next, the dried pieces were ground using any conventional low temperature pulverizer to obtain a flour with particle size in the range of 200-1000 µm, preferably 500 µm. The jackfruit flour as prepared can also be dried by freeze dying/lyophilization method in order to further preserve its nutritional properties. As disclosed in the specification, the fruit only flour can be processed using freeze drying method to enhance and preserve the nutritional content of the final product. This freeze dried flour component can be used to supplement the dietary fiber component, in particular to have higher soluble fiber to insoluble fiber ratio of the flour obtained from seeds, fruits, and strands by hot air drying method as discussed, or by any other method.

### Example 3 Jackfruit Flour as a Substitute or Additive

In order to use the jackfruit flour of the present disclosure as a viable complete or partial substitute, or additive to other flours as described elsewhere in the present disclosure, it is important that binding characteristics of the final product are maintained and are similar to that of the unsubstituted flour. Towards, it was found that maintaining a soluble fiber weight percentage of about 4% in the jackfruit flour provides sufficient binding properties such that the final food product has desired consistency and is not dry or brittle. The jackfruit flour of the present disclosure can be used to substitute traditional flours such as rice and wheat from 10-99%, preferably 30-99%, more preferably 30-60% in order to lower glycemic value, reduce calorie intake, and increase fiber content. It is to be noted that substitution of traditional flours with jackfruit flour does not significantly alter the texture or taste characteristics. It is also to be noted that the jackfruit flour of the present disclosure can also be used as a stand alone flour to prepare various food items, which are otherwise made from traditional flours such as wheat, rice, barley, millet, and others. The jackfruit flour can also be used as a meat additive or substitute.

The jackfruit flour as described and prepared by a method as described herein, can also be reconstituted with water to obtain a batter having moisture content in the range of 65-80%.

Jackfruit flour as described and prepared by a method as described herein, can also be reconstituted with water to obtain a dough having moisture content in the range of 40-60%. The dough can be further dried using any method to reduce the moisture content to less than 8%.

The jackfruit flour as described and prepared by a method as described herein, can also be reconstituted with water and subsequently dried by any method known in art to obtain a dough having moisture content in the range of 40-60%. The dough can be further dried using any method to reduce the moisture content to less than 8%.

It is also contemplated that a batter, or dough made of jackfruit flour as described previously, can also be made directly without reconstitution of jackfruit flour with water. Jackfruit parts as described elsewhere can be directly processed to make batter or dough for use as food product or raw material.

For any of the drying processes/step as described and otherwise contemplated, such methods can be air drying, hot air drying, vacuum drying, freeze drying, or any other method suitable to achieve the features and characteristics of the desired product.

Some of the food products which can be made using the jackfruit flour, or reconstituted jackfruit flour, or composition comprising jackfruit extract, or fortified flour comprising jackfruit flour as described throughout the specification can be, but are not limited to pasta, idli, dosas, bakery products such as cookies, , vegan burgers, meat burgers, noodles, pizza base, etc.

Overall, the present disclosure provides a jackfruit flour, and method of preparing the same, prepared from various parts of the whole fruit. The jackfruit flour has high fiber content, superior nutritional content, and has a lower GL value, and is gluten free, which can be as a substitute or additive to various food preparations which otherwise use some kind of flour. The jackfruit flour prepared by utilizing various parts has a nutrition profile similar to that when the fleshy pulp alone is used, thus the percent utilization of a whole jackfruit in the instant case is higher, and consequently, the costs are lower. The jackfruit flour of the instant disclosure provides desired binding, consistency, and minimal to no perceived change in taste or texture, which is otherwise missing in healthy alternatives such as millet flour, hence jackfruit flour is more palatable.

I/We claim:

1-26. (canceled)

27. A method of reducing the glycemic load of food, said method comprising the steps of:
a) obtaining a jackfruit flour or dough consisting of:
i) particles of jackfruit flesh,
ii) particles of jackfruit seeds,
iii) particles of jackfruit strands, and
iv) moisture
wherein the jackfruit flour or dough consists of the following nutritional values:
A) 0.3-1.5 w/w% total fats only from the jackfruit flesh, jackfruit seeds, jackfruit strands or combinations thereof; wherein total fats do not comprise detectable levels of saturated fats;
B) 7-9 w/w% protein only from the jackfruit flesh, jackfruit seeds, jackfruit strands or combinations thereof; and
C) 78-82 w/w% of carbohydrates only from the jackfruit flesh, jackfruit seeds, jackfruit strands or combinations thereof, consisting of:
a) 12-16 w/w% of dietary fibers only from the jackfruit flesh, jackfruit seeds, jackfruit strands or combinations thereof, consisting of:
i) 3 to 6 w/w% soluble fiber only from the jackfruit flesh, jackfruit seeds, jackfruit strands or combinations thereof,
ii) 8 to 12 w/w% insoluble fiber only from the jackfruit flesh, jackfruit seeds, jackfruit strands or combinations thereof;
b) 3 to 11 w/w% of sugar only from the jackfruit flesh, jackfruit seeds, jackfruit strands or combinations thereof; and
c) other carbohydrates, only from the jackfruit flesh, jackfruit seeds, jackfruit strands or combinations thereof,
wherein the particles of the jackfruit flesh, jackfruit seeds and jackfruit strands consist of particles in the size range of 200-1000 µm; and
b) contacting said flour or dough composition with food, wherein said flour or dough composition weight percentage is in the range of about 10-99%.

28. The method of claim 27, wherein the jackfruit flour comprises a moisture content of less than 8 wt%.

29. The method of claim 27, wherein the jackfruit flour comprises a moisture content in the range of 40-60%.

30. The method of claim 27, wherein the flour or dough is a fortified flour or dough.

31. The method of claim 30, wherein the fortified flour or dough comprises jackfruit flour in the range of 10%-99%.

32. The method of claim 30, wherein the fortified flour or dough comprises at least one additional flour selected from the group consisting of wheat, barley, rye, rice, millet, oat, acorn, amaranth, banana, buckwheat, cassava, chestnut, chickpea, coconut, maize, cornstarch, flax, plea, potato, sorghum, tapioca, teff, and combinations thereof.

33. The method of claim 30, wherein the fortified flour or dough comprises at least one fortifier selected from the group consisting of vitamins, minerals, whole vegetable extracts or extracts of parts thereof, gums and combinations thereof.

34. The method of claim 27, wherein the method further comprises preparing the jackfruit flour comprising the steps of:
a) obtaining jackfruit, wherein said jackfruit has seeds which will slip out of the fruit when cut by half;
b) isolating the combination of jackfruit flesh, seeds and strands from said jackfruit; and
c) grinding the combination of jackfruit flesh, seeds and strands to particle size in the range of 200-1000 µm to obtain the jackfruit flour.

35. The method of claim 34, wherein the method further comprises the step of drying the combination of jackfruit flesh, seeds and strands to achieve moisture content less than about 8 wt%.

36. A method of reducing the glycemic load and increasing fiber content of food, said method comprising the steps of:
a) obtaining a jackfruit flour or dough consisting of:
i) particles of jackfruit flesh,
ii) particles of jackfruit seeds,
iii) particles of jackfruit strands, and
iv) moisture
wherein the jackfruit flour or dough consists of the following nutritional values:
A) 0.3-1.5 w/w% total fats only from the jackfruit flesh, jackfruit seeds, jackfruit strands or combinations thereof; wherein total fats do not comprise detectable levels of saturated fats;
B) 7-9 w/w% protein only from the jackfruit flesh, jackfruit seeds, jackfruit strands or combinations thereof; and
C) 78-82 w/w% of carbohydrates only from the jackfruit flesh, jackfruit seeds, jackfruit strands or combinations thereof, consisting of:
a) 12-16 w/w% of dietary fibers only from the jackfruit flesh, jackfruit seeds, jackfruit strands or combinations thereof, consisting of:
i) 3 to 6 w/w% soluble fiber only from the jackfruit flesh, jackfruit seeds, jackfruit strands or combinations thereof,
ii) 8 to 12 w/w% insoluble fiber only from the jackfruit flesh, jackfruit seeds, jackfruit strands or combinations thereof;
b) 3 to 11 w/w% of sugar only from the jackfruit flesh, jackfruit seeds, jackfruit strands or combinations thereof; and
c) other carbohydrates, only from the jackfruit flesh, jackfruit seeds, jackfruit strands or combinations thereof,
wherein the particles of the jackfruit flesh, jackfruit seeds and jackfruit strands consist of particles in the size range of 200-1000 µm; and
b) contacting said flour or dough composition with food, wherein said flour or dough composition weight percentage is in the range of about 10-99%.

37. The method of claim 36, wherein the jackfruit flour comprises a moisture content of less than 8 wt%.

38. The method of claim 36, wherein the jackfruit dough comprises a moisture content in the range of 40-60%.

39. The method of claim 36, wherein the flour or dough is a fortified flour or dough.

40. The method of claim 39, wherein the fortified flour or dough comprises jackfruit flour in the range of 10%-99%.

41. The method of claim 39, wherein the fortified flour or dough comprises at least one additional flour selected from the group consisting of wheat, barley, rye, rice, millet, oat, acorn, amaranth, banana, buckwheat, cassava, chestnut, chickpea, coconut, maize, cornstarch, flax, plea, potato, sorghum, tapioca, teff, and combinations thereof.

42. The method of claim 39, wherein the fortified flour or dough comprises at least one fortifier selected from the group consisting of vitamins, minerals, whole vegetable extracts or extracts of parts thereof, gums and combinations thereof.

43. The method of claim 36, wherein the method further comprises preparing the jackfruit flour comprising the steps of:
a) obtaining jackfruit, wherein said jackfruit has seeds which will slip out of the fruit when cut by half;
b) isolating the combination of jackfruit flesh, seeds and strands from said jackfruit; and
c) grinding the combination of jackfruit flesh, seeds and strands to particle size in the range of 200-1000 µm to obtain the jackfruit flour.

44. The method of claim 43, wherein the method further comprises the step of drying the combination of jackfruit flesh, seeds and strands to achieve moisture content less than about 8 wt%.

45. A method of preparing a food product for consumption by a diabetic subject, the method comprising the steps of:
a) obtaining a jackfruit flour or dough consisting of:
i) particles of jackfruit flesh,
ii) particles of jackfruit seeds,
iii) particles of jackfruit strands, and
iv) moisture
wherein the jackfruit flour or dough consists of the following nutritional values:
A) 0.3-1.5 w/w% total fats only from the jackfruit flesh, jackfruit seeds, jackfruit strands or combinations thereof; wherein total fats do not comprise detectable levels of saturated fats;
B) 7-9 w/w% protein only from the jackfruit flesh, jackfruit seeds, jackfruit strands or combinations thereof; and
C) 78-82 w/w% of carbohydrates only from the jackfruit flesh, jackfruit seeds, jackfruit strands or combinations thereof, consisting of:
a) 12-16 w/w% of dietary fibers only from the jackfruit flesh, jackfruit seeds, jackfruit strands or combinations thereof, consisting of:
i) 3 to 6 w/w% soluble fiber only from the jackfruit flesh, jackfruit seeds, jackfruit strands or combinations thereof,
ii) 8 to 12 w/w% insoluble fiber only from the jackfruit flesh, jackfruit seeds, jackfruit strands or combinations thereof;
b) 3 to 11 w/w% of sugar only from the jackfruit flesh, jackfruit seeds, jackfruit strands or combinations thereof; and
c) other carbohydrates, only from the jackfruit flesh, jackfruit seeds, jackfruit strands or combinations thereof,
wherein the particles of the jackfruit flesh, jackfruit seeds and jackfruit strands consist of particles in the size range of 200-1000 µm; and
b) contacting said flour or dough composition with food, wherein said flour composition weight percentage is in the range of about 10-99%.

46. The method of claim 45, wherein the flour or dough is a fortified flour or dough.
